(19) United States
(12) Patent Application Publication
(10) Pub. No.: US 2012/0252524 A1
(43) Pub. Date: Oct. 4, 2012

(54) Uplink Power Control for Lower Power Nodes

(76) Inventors: Jacek Gora, Wroclaw (PL); Agnieszka Szufarska, Gdansk (PL); Claudio Rosa, Randers (DK)

(21) Appl. No.: 13/505,853

(22) PCT Filed: Nov. 3, 2009
(86) PCT No.: PCT/EP09/64540

§ 371 Date: Jun. 11, 2012

(51) Int. Cl. H04W 52/04

(52) U.S. Cl. 455/522

(57) ABSTRACT

A method and an apparatus are described, in which a transmission power related parameter used for determining an uplink transmission power for a first cell based on the relational parameter, which indicates a relationship between the first cell and the second cell.

### FIELD OF THE INVENTION

The present invention relates to an apparatus, method and computer program product for related to an uplink power control for lower power nodes (e.g., femto cells).

### RELATED BACKGROUND ART

The following meanings for the abbreviations used in this specification apply:

3GPP—3rd generation partnership project

CSG—Closed Subscriber Group

DL—Downlink

eNB—eNode B (LTE base station)

HeNB—Home eNode B

HII—High Interference Indicator

LeNB—Local eNode B

LTE—Long term evolution

LTE-A—LTE-Advanced

MCS—Modulation and coding scheme

OAM—Operation, administration and maintenance

OI—Overload Indicator

UE—User equipment

UL—Uplink

WA—Wide area

WAeNB—Wide Area eNode B

The present application relates to mobile wireless communications, such as 3GPP Long-Term Evolution (LTE and LTE-A). It is related more specifically to network optimization, automated configuration and interference reduction in case of wide area with so-called femto cells (Home eNB, HeNB) co-channel deployment. The present application is, however, not limited to HeNBs only, but considers general low power (local) nodes (LeNB) deployed in an uncoordinated manner, and which are under an overlay wide area macro network operated on the same frequency layer.

Femto cells are a base station class with lower maximum transmit power with relation to typical macro LTE eNB and are typically designed for indoor deployments—in private residences or public areas (e.g. office). As the femto cells are intended to be deployed and maintained individually by customers, their geographical location can not be assumed as known to the operator. Moreover, as the number of femto cells within macro cell area can eventually be large, the configuration of LeNB or HeNB parameters from a centralized OAM (operation, administration and maintenance) may be difficult.

In many cases customers would also like to secure for themselves a sufficient amount of resources at their HeNBs and protect it from unwanted access. To do so they will use the Closed Subscriber Group (CSG) configuration in which they will be able to define the list of authorized subscribers who will have access to their femto-cells. Because UEs will not always be allowed to connect to the base station that provides the best radio conditions, the CSG scheme can pose a serious threat to the functionality of the network from the interference point of view.

To utilize the spectrum as efficiently as possible, co-channel deployment of low power (local) nodes (e.g. LeNBs or HeNBs) and the wide area eNBs is seen as an important use case in 3GPP standardization. In LTE/LTE-A all the transmissions within one cell are planned to be orthogonal. It means that in the ideal case there is no interference between users connected to the same eNB. The only interference that has to be taken into account comes from transmission of users connected to neighbouring eNBs that are scheduled to use the same frequency resources.

In case of low power nodes, with a co-channel wide area network overlay, the interference coordination and mitigation is a serious issue. In case of the uplink connection both the local and wide area users can be threatened. As the users connected to the local nodes will normally have lower path loss to the serving base station, they will use lower transmission power than the users connected to a wide area eNB. Though the interference they generate at the eNB would also be lower than the interference perceived at local cell originated in wide area users.

An example for this is shown in FIG. 7, in which a UE-eNB connection and a UE-HeNB (LeNB) connection are shown. At the eNB on the left side of the diagram, the interference caused by the UE-HeNB connection (illustrated by the lower curve) is low, whereas near the HeNB at the right side of the diagram, the interference caused by the UE-eNB connection (illustrated by the upper curve in the drawing) is rather high.

With the CSG configuration a case is highly possible that a user not allowed connecting to HeNB has to connect with a high transmission power to a far wide area eNB and though generates a lot of interference at the nearby HeNB. On the other hand if the uplink power setting for the HeNB users is too high, the wide area users are the ones suffering.

Hence, there is a need to avoid or suppress interference in a network, in particular when there are small cells having low power overlaid by a macro cell network.

### SUMMARY OF THE INVENTION

Thus, it is an object of the present invention to overcome the above problem of the prior art.

According to several embodiments of the present invention, this is accomplished by a method and apparatus, in which a transmission power related parameter used for determining an uplink transmission power for a first cell based on the relational parameter, which indicates a relationship between the first cell and the second cell.

According to more detailed embodiments, the first cell may be a local node such as a LeNB or HeNB, the second cell may be a wide area eNB, and the relationship may be a relative position of the two cells, so that in this case the uplink transmission power is determined based on a parameter based on the relative position of the two cells, such as a pathloss between the first cell and the second cell or an estimated average level of interference perceived at the position of the apparatus.

### BRIEF DESCRIPTION OF THE DRAWINGS

These and other objects, features, details and advantages will become more fully apparent from the following detailed description of embodiments of the present invention which is to be taken in conjunction with the appended drawings, in which:

FIGS. 1A and 1B show simplified structures of a LeNB and a OAM according to embodiments of the present invention,

FIGS. 2A and 2B show processes carried out by a LeNB and a OAM according to embodiments of the present invention,

FIGS. 3 to 6 show simulation results, and

FIG. 7 illustrates UL interference propagation in case of wide area and femto cell co-existence

### DETAILED DESCRIPTION OF EMBODIMENTS

In the following, description will be made to embodiments of the present invention. It is to be understood, however, that the description is given by way of example only, and that the described embodiments are by no means to be understood as limiting the present invention thereto.

As described above, several embodiments of the present invention are directed to the problem of reducing interference in case of overlaid femto cells and wide area network cell. In order to guarantee proper radio conditions for all wide area and femto users in all locations, an adaptive uplink power control scheme can be used. The LTE uplink power control mechanism is described in 3GPP TS 36,213 v.8.8.0, for example. According to this document, each base station controls the transmission power of the users connected to it, based on:
downlink eNB-UE pathloss estimate calculated in the UE and reported to eNB
parameters provided from higher network layers

This approach is sufficient in case of a coordinated deployment. The parameters of the power control algorithm can than be chosen for optimal cell capacity and/or coverage, based on the relative positions of sites. With an uncoordinated deployment (e.g. deployment of femto-cells) the exact position of nodes is not known to the operator. In that case it is not possible to set the optimal power control parameters a priori. It is especially not possible when the deployment can change over time, as it would be possible in case of femto-cells.

Thus, according to several embodiments of the present invention, a way of adaptive power control parameters' selection is applied.

In particular, according to several embodiments, a transmission power related parameter, which is used for determining an uplink transmission power, is calculated based on a relational parameter indicating a relationship between a small cell (first cell, e.g., a LeNB (local eNode B) or a HeNB) and a large cell (second cell, e.g., an eNB). The relational parameter is also referred to as a relationship-dependent parameter. Examples for this parameter will be given in the following.

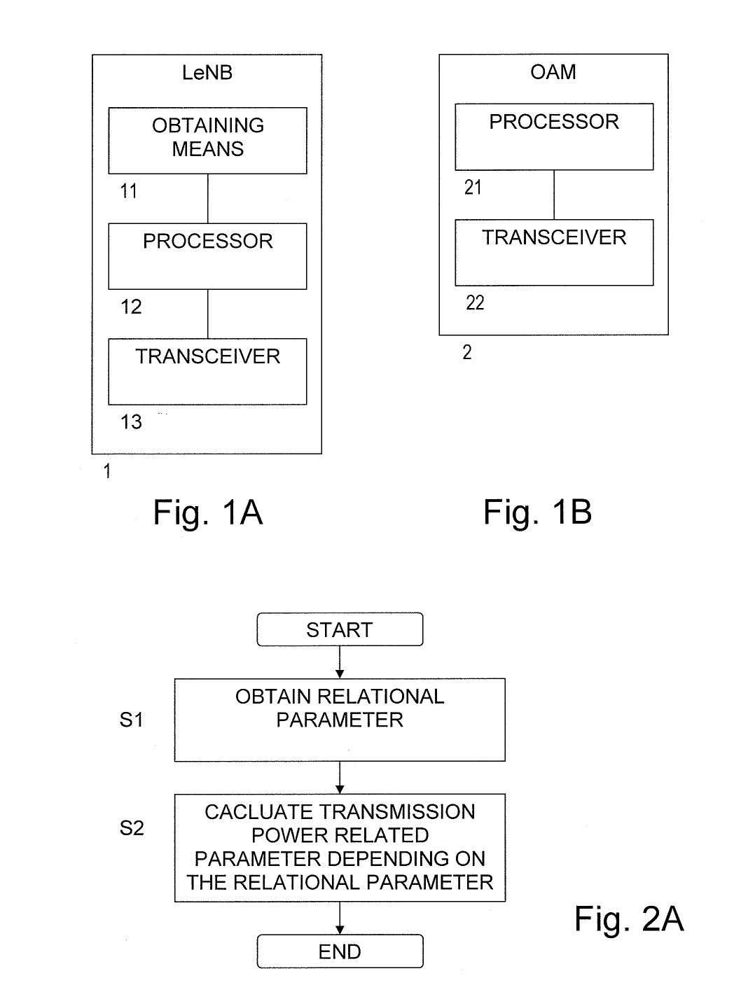

This is described in more detail by referring to FIG. 1A. FIG. 1A shows a LeNB 1 as an example for an apparatus, such as a network control apparatus. The LeNB comprises an obtaining means 11, a processor 12 and (optionally) a transceiver 13. The obtaining means 11 obtains the relational parameter mentioned above, which is described in more detail in the following. The processor 12 calculates the transmission power related parameter depending on the relational parameter.

The obtaining means 11 may comprise a receiver which is configured to receive measurements with respect to the relational parameter from a user equipment or a user equipment receiver configured to perform measurements with respect to the relational parameter. The optional transceiver 13 may establish a connection to a network configuration apparatus such as an OAM 2 shown in FIG. 1B.

The OAM 2 according to several embodiments of the present invention comprises a transceiver (or a receiver) 21 and a processor 22. The transceiver receives a transmission power related parameter from a first network control apparatus such as the LeNB 1 shown in FIG. 1A. As mentioned above, the transmission power related parameter depends on the relational parameter indicating a relationship between the first cell and the second cell, the second cell being larger than the first cell. The processor 22 determines a power command parameter for the first network control apparatus based on the transmission power related parameter.

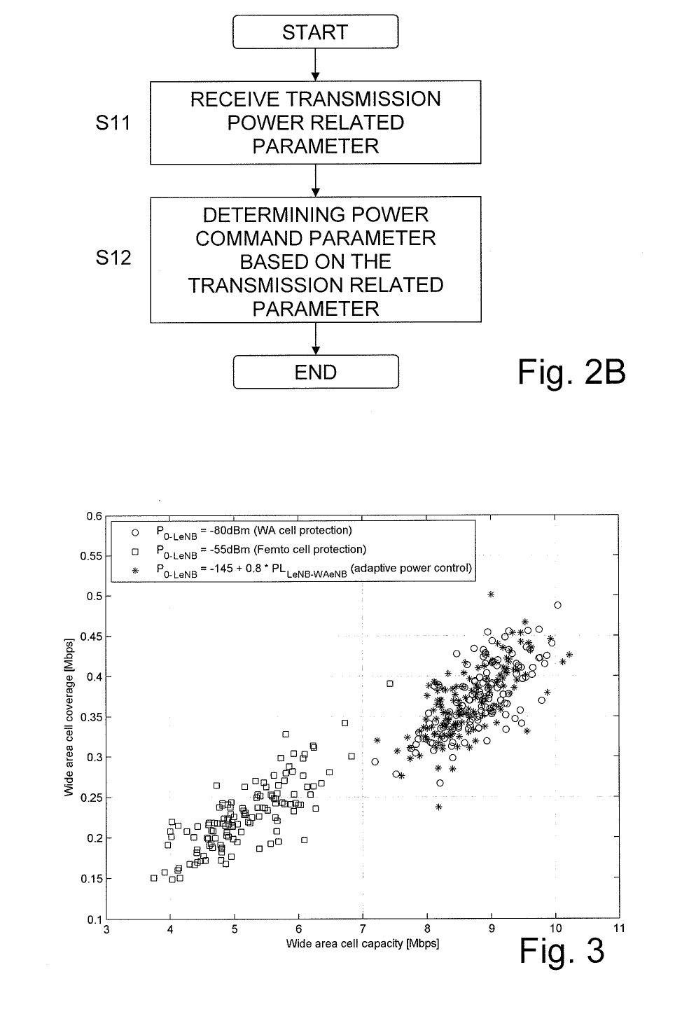

FIGS. 2A and 2B show processes according to several embodiments of the present invention. In particular, FIG. 2A shows a process, which may be carried out by a network control apparatus such as a HeNB or LeNB as described above. In step S1, a relational parameter indicating a relationship between a first cell and a second cell is obtained, and in step S2 a transmission power related parameter used for determining an uplink transmission power for the first cell based on the relational parameter is calculated.

FIG. 2B shows a process, which may be carried out by a network configuration apparatus such as a OAM as described above. In step S11, a transmission power related parameter is received from a first network control apparatus controlling a first cell. As mentioned above, the transmission power related parameter depends on a relational parameter indicating a relationship between the first cell and a second cell. In step S12, a power command parameter for the first network control apparatus is determined based on the transmission power related parameter.

Thus, the transmission power related parameter is calculated based on a relational parameter, which may depend on the relative position of the first cell in respect to the second cell. This is explained in the following by referring to more detailed examples in the following:

Currently the uplink transmission power is set according to the formula:

Pₜₓ=min{P_{Max}, Pₒ+α*PL+10*log₁₀ M+Δ_{MCS}+f(Δᵢ) }

Where:
P_{Max}: maximal UE transmission power
Pₒ: parameter related to averaged received SINR
α: pathloss compensation factor
PL: downlink eNB-UE pathloss estimate calculated in the UE
M: number of resources scheduled for the considered UE
Δ_{MCS}: user specific, MSC depended correction value
f(Δᵢ): user specific correction value

Parameters that have the biggest impact on the overall power setting are the cell specific settings Pₒ and α. The user specific parameters have minor effect on the overall power setting.

To optimize the formula for the case of an uncoordinated deployment, the Pₒ parameter should depend on the relative position of the small cell (e.g. LeNB or HeNB) in respect to the wide area sites, i.e., the parameter should depend on the relationship between the small cell and the larger cell. To do so, a procedure is proposed:
1. The local base station (LeNB) calculates the value of the Pₒ parameter (two ways are exemplified, other possibilities, modifications or hybrids can also be conceived):
   a) The local base station estimates the pathloss to the nearest wide area eNB using an integrated UE receiver or utilizing UEs' measurements. The value of the Pₒ parameter can be than calculated as a function of the estimated pathloss:

P_{o-LeNB}=min{P_{o MAX}, Aₐ+Bₐ*PL_{LeNB-eNB}}
Where:
P_{o-LeNB}—parameter Pₒ optimized for the considered local (low power) base station
P_{o MAX}—maximum value of the P_{o-LeNB} parameter, predefined or signaled from the network
PL_{LeNB-eNB}—estimated pathloss between the local base station and the closest wide area eNB (also referred to as PL_{LeNB-WAeNB})
Aₐ, Bₐ—parameters that can be predefined, operator specific or signaled from the network (e.g. by the network element responsible for configuration or by the overlay wide area eNB on broadcast control channel)
Thus, according to option a), the relational parameter is the estimated pathloss PL_{LeNB-eNB}.
b) The local base station estimates the average level of interference using an integrated UE receiver or utilizing UEs' measurements. The value of the Pₒ parameter can be than calculated as a function of the estimated expected interference:

P_{o-LeNB}=min{P_{o MAX}, A_{b}+B_{b}*I_{LeNB}}
Where:
P_{o-LeNB}—parameter Pₒ optimized for the considered local (low power) base station (LeNB)
P_{o MAX}—maximal value of the P_{o-LeNB} parameter, predefined or signaled from the network
I_{LeNB}—estimated average level of interference perceived at the position of local base station
A_{b}, B_{b}—parameters that can be predefined, operator specific or signaled from the network (e.g. by the network element responsible for configuration or by the overlay wide area eNB on broadcast control channel)
Thus, according to option b), the relational parameter is the estimated estimated average level of interference I_{LeNB}.
2. Local base station reports to the network element responsible for configuration (OAM entity) the chosen value of the P_{o-LeNB} parameter together with an estimated LeNB-eNB pathloss.
3. The OAM entity checks if the uplink power levels set according to the proposed P_{o-LeNB} will not cause too much interference to the neighboring wide area eNBs. It is done basing on:
   the reported estimated LeNB-eNB pathloss
   the known settings of the power control algorithm at the eNB and/or
   level of uplink interference perceived by the wide area eNBs and signaled to the OAM entity (Overload Indicator, OI)
4. The OAM entity answers with an ACK to the local base station when the P_{o-LeNB} setting is appropriate or with a NACK and a new P_{o MAX} when the reported P_{o-LeNB} value is too high. Alternatively: in the case of NACK, the OAM (i.e., the network) provides the preferred parameter (i.e., P_{o MAX}) as a response, but taking into account the value proposed by the LeNB. Thus, in this way it can be assured that in case of too high power settings the OAM has still the possibility to command the LeNB to reduce uplink power by assigning P_{0 Max} which should be obeyed, wherein, however, the OAM may take into account the preferred LeNB parameter settings when deciding on the P_{0 Max} value to be sent.

From the local node point of view, the higher the user transmission power, the higher throughput it will reach. So the LeNB should select P_{o-LeNB} values optimal for itself (high P_{o-LeNB}), whereas the network element responsible for configuration should keep the wide area eNBs protected (setting P_{o MAX} limit).

The P_{0-LeNB} settings can in some extent be altered by the user specific correction values. To avoid that, in order to protect the performance of the wide area users, the following measures can be effected:
Block the possibility to accumulate correction values (f(Δᵢ)) for users connected to local area nodes (possibly also block the absolute correction values for local area nodes as well).
Restrict the amount of correction values that can be applied (accumulated and/or absolute) in respect to P_{0-LeNB} setting (min{P_{Δmax}, P_{0-LeNB}+f(Δᵢ)}). That is, the f(Δᵢ)when applied may accumulate to an undesirable value. If not blocked (as in previous point) it is also possible to restrict the amount of such corrections, for example not to exceed a total correction of P_{Δmax}.

Both measures can be commanded by the OAM, e.g., when sending the P_{o MAX} to the local node, when sending ACK or NACK or the like, or can be commanded by the local node.

If the X2 interface is available at the local nodes then a further modification of the embodiments described above is possible:

To optimize this mechanism, the OAM entity takes into account the High Interference Indicator (HII) and Overload Indicator (OI) information send over the X2 interface, and dynamically influence the maximum values of the P_{o-LeNB} parameter used by low power base stations (P_{o MAX}). When LeNBs indicate using HII on which resources they schedule users, than the OAM entity would know which LeNBs are responsible for interference on specific PRBs. This would further allow more precise addressing of the power control restrictions only to the specific LeNBs (the ones that interfere the most on the indicated PRBs). The availability of the X2 interface at the local nodes would also allow more complex interference coordination, e.g. LeNB vs. LeNB.

The described power control mechanism would be implemented e.g. in the LeNB. The needed measurements can by done by a UE receiver implemented in the LeNB or measurements from UEs can be used. The potential gains from the implementation of the proposed method would be noticeable in the available cell capacity and cell coverage values in cases of femto-cell and wide area co-existence.

In the following, some simulation examples are described by referring to FIGS. 3 to 6.

In particular, to support the validity of the proposed scheme, simulations have been done using the following scenario:
Number of wide area cells: 57
Number of femto cells: 10 per each wide area cell
Number of users: 25 wide area users+1 femto user near each femto cell
Configuration of femto cells: CSG, only the femto users can connect to their own LeNBs
Traffic model: full buffer
Scheduler: round robin

The investigated performance metrics were:
Cell capacity—aggregated user throughput
Cell coverage—5%-ile user throughput multiplied by the number of users connected to the considered base station

Three cases have been investigated:
Wide area cell protection:P_{o-LeNB}=−80 dBm (prior art approach)
Femto-cell protection: P_{o-LeNB}=−55 dBm (prior art approach)
Adaptive power control: P_{o-LeNB}=−145 dBm+0.8*PL_{LeNB-WAeNB} (proposed method)

Thus, according to the prior art approaches, fixed values for P_{o-LeNB} are used, whereas in the adaptive power control, the value of P_{o-LeNB} is variable based on PL_{LeNB-WAeNB} (also referred to as PL_{LeNB-eNB}). That is, in the present simulations approach a) described above is used, wherein parameter Aₐ=145 dBm, and parameter Bₐ=0.8).

It is noted that in all FIGS. 3 to 6 a circle (∘) indicates the WA cell protection, a square (□) indicates the femto cell protection, and a star (*) indicates the adaptive power control according to the embodiment described above.

The results of the simulation are shown in the following plots (FIGS. 3 to 6) and in Table 1.

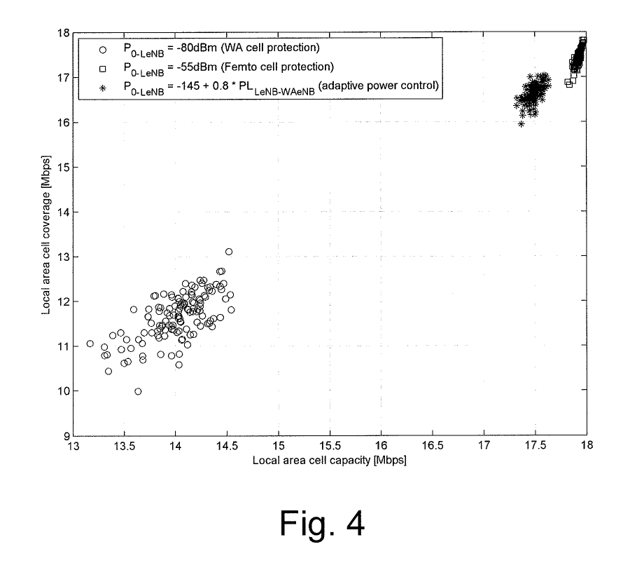

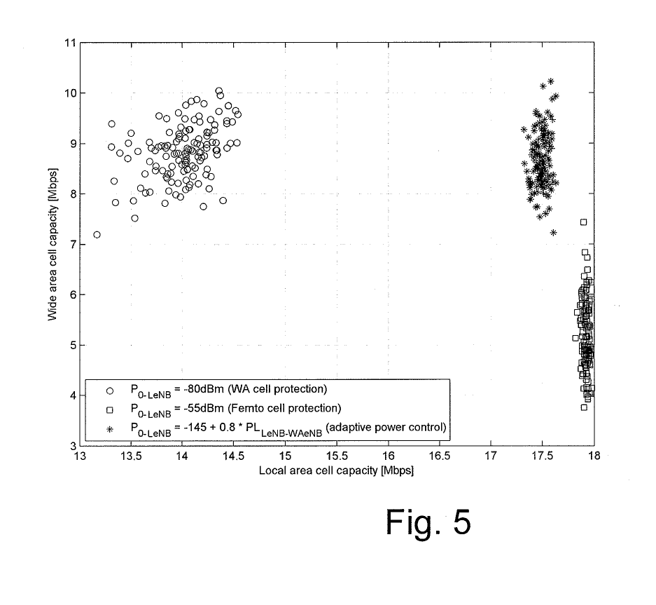

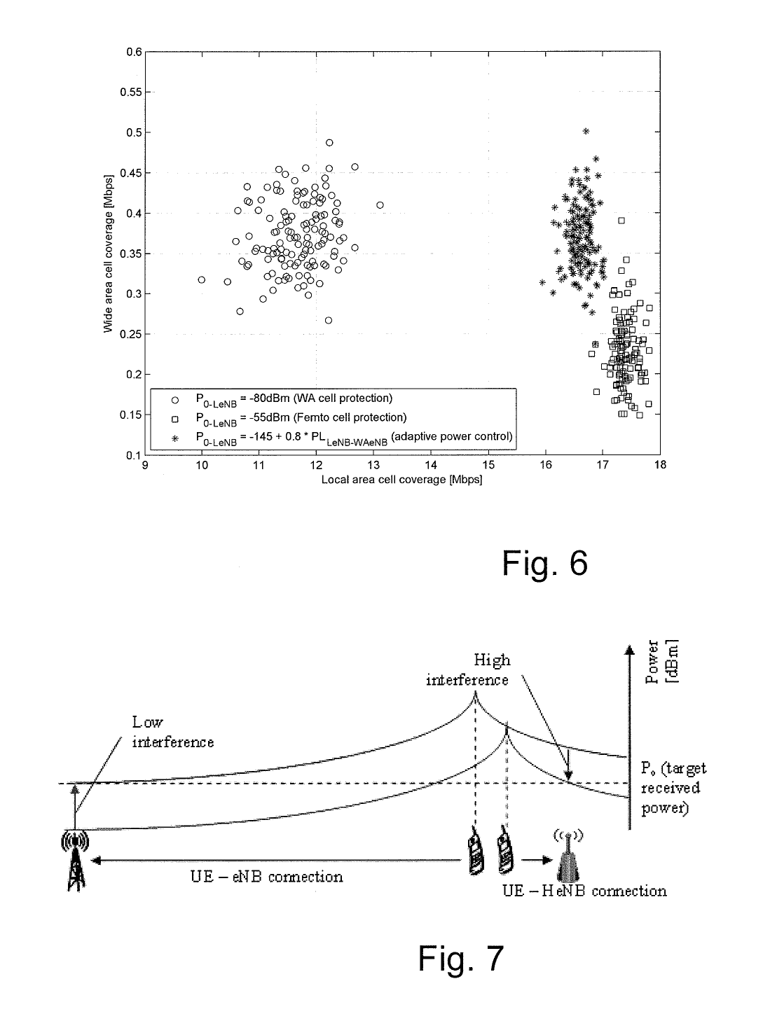

In detail, FIG. 3 shows the performance of the wide area users, wherein the wide area cell coverage [Mbps] is plotted over the wide area cell capacity [Mbps]. FIG. 4 shows the performance of the local cell (femto cell) users, wherein the local area cell coverage [Mbps] is plotted over the local area cell capacity [Mbps]. FIG. 5 shows the capacity of the wide area cell and local cells (femto cells), wherein the wide area cell capacity [Mbps] is plotted over the local area cell capacity [Mbps]. FIG. 6 shows coverage of the wide area cell and local cells (femto cells), wherein the wide area cell coverage [Mbps] is plotted over the local area cell coverage [Mbps].

TABLE 1
Summary of the performance metrics for the investigated cases

| | | | P_{o-LeNB} = | P_{o-LeNB} = |
|---|---|---|---|---|
| | | P_{o-LeNB} = −80 | −145 dBm + 0.8 * | −55 |
| | | dBm | PL_{LeNB-ENB} | dBm |
| Wide | Avg. | 8.82 | 8.65 | 5.18 |
| area | capacity | (+2.0%)¹⁾ | | (−40.1%)¹⁾ |
| cell | [Mbps] | | | |
| | Avg. | 0.373 | 0.368 | 0.227 |
| | coverage | (+1.4%)¹⁾ | | (−38.3%)¹⁾ |
| | [Mbps] | | | |
| Femto | Avg. | 14.01 | 17.49 | 17.92 |
| cell | capacity | (−19.9%)¹⁾ | | (+2.5%)¹⁾ |
| | [Mbps] | | | |
| | Avg. | 11.66 | 16.62 | 17.39 |
| | coverage | (−29.8%)¹⁾ | | (+4.6%)¹⁾ |
| | [Mbps] | | | |

¹⁾The values in brackets indicate percentages compared to the proposed method of adaptive power control according to embodiments of the present invention.

From the results presented above it is clearly visible that the proposed method of setting transmission power for femto users brings high performance increase compared to the two cases consistent with the existing algorithm.

Comparing the proposed method to the low P_{o-LeNB} case (wide area cell protection), the performance of the femto users increases significantly (+19.9% in capacity, +29.8% in coverage), whereas the performance of the wide area users drops only by few percent (−2.0% in capacity, −1.4% in coverage).

Comparing the proposed method to the high P_{o-LeNB} case (femto cell protection) the performance of the wide area users increases significantly (+40.1% in capacity, +38.3% in coverage), whereas the performance of the femto users drops only by few percent (−2.5% in capacity, −4.6% in coverage).

It is noted that the above embodiments are to be taken only as examples, and numerous modifications are possible.

It is noted that the above embodiments were mainly described in relation to 3GPP specifications. However, this is only a non-limiting example for certain exemplary network configurations and deployments. Rather, any other network configuration or system deployment, etc. may also be utilized as long as compliant with the features described herein.

In particular, embodiments of the present invention may be applicable in any system in which there are small cells and wide area sites. Embodiments of the present invention may be applicable for/in any kind of modern and future communication network including mobile/wireless communication networks, such as for example Global System for Mobile Communication (GSM), General Packet Radio Service (GPRS), Universal Mobile Telecommunication System (UMTS), Wideband Code Division Multiple Access (WCDMA), Long-Term Evolution (LTE), Long-Term Evolution Advanced (LTE-A), Wireless Interoperability for Microwave Access (WiMAX), evolved High Rate Packet Data (eHRPD), Evolved Packet Core (EPC), or other 3GPP (3GPP: Third Generation Partnership Project) or IETF (Internet Engineering Task Force) networks.

According to a first aspect of several embodiments of the invention, an apparatus is provided which comprises:
an obtainer (obtaining means) configured to obtain a relational parameter indicating a relationship between a first cell and a second cell, and
a processor configured to calculate a transmission power related parameter used for determining an uplink transmission power for the first cell based on the relational parameter.

The first aspect may be modified as follows:

The relationship may be a relative position between the first cell and the second cell.

The relational parameter may be an estimated pathloss between the first cell and the second cell.

The processor may be configured to calculate the transmission power related parameter based on the following formula:

P_{o-LeNB}=min{P_{o MAX}, Aₐ+Bₐ*PL_{LeNB-eNB}}
wherein P_{o-LeNB} is the transmission power related parameter, P_{o MAX} is a maximum value of the transmission power related parameter, PL_{LeNB-eNB} is the estimated pathloss between the first cell and the second cell, and Aₐ and Bₐ are predefined parameters.

The relational parameter may be an estimated average level of interference perceived at the position of the apparatus.

The processor may be configured to calculate the transmission power related parameter based on the following formula:

P_{o-LeNB}=Min{P_{o MAX}, A_{b}+B_{b}*I_{LeNB}}
wherein P_{o-LeNB} is the transmission power related parameter, P_{o MAX} is a maximum value of the transmission power related parameter, I_{LeNB} is the estimated average level of interference perceived at the position of the apparatus, and A_{b} and B_{b} are predefined parameters.

The apparatus may be a first network control apparatus (e.g., a LeNB or a HeNB) serving the first cell, and the second cell is served by a network control apparatus (e.g., an eNB or a WAeNB) being nearest to the first network control apparatus.

The apparatus may further comprise a transceiver configured to send the transmission power related parameter and/or the relational parameter to a network configuration apparatus.

The transceiver may be configured to receive a power command parameter for setting a transmission power from the network configuration apparatus, wherein the processor may be configured to set the transmission power based on the power command parameter.

The obtainer (obtaining means) may comprise a receiver which is configured to receive measurements with respect to the relational parameter from a user equipment or a user equipment receiver configured to perform measurements with respect to the relational parameter.

The processor may be configured to set the uplink transmission power by taking into account correction values, and to restrict the correction values.

The processor may be configured to restrict the correction values by blocking a possibility of accumulating user correction values or correction values of the apparatus, and/or by restricting the amount of correction values to be used for setting the uplink transmission power.

According to a second aspect of several embodiments of the present invention, an apparatus is provided which comprises:
a receiver configured to receive a transmission power related parameter from a first network control apparatus controlling a first cell, wherein the transmission power related parameter depends on a relational parameter indicating a relationship between the first cell and a second cell,
a processor configured to determine a power command parameter for the first network control apparatus based on the transmission power related parameter.

The second aspect may be modified as follows:

The processor may be configured to determine the power command parameter based on at least one of the following:
the relational parameter, and/or
settings of a power control algorithm of a second network control apparatus serving the second cell, and/or
level of uplink interference perceived by the second network control apparatus.

The relational parameter may be an estimated pathloss between the first cell and the second cell, and/or the relational parameter may be an estimated expected interference between the first cell and the second cell.

The processor may be configured to use an interference indicator and/or an overload indicator for modifying the power command parameter.

The processor may be configured to restrict correction values to be used for setting a transmission power of a user equipment by blocking a possibility of accumulating user correction values or correction values, and/or by restricting the amount of correction values to be used for setting the uplink transmission power.

According to a third aspect of several embodiments of the invention, an apparatus is provided which comprises:
Means for obtaining a relational parameter indicating a relationship between a first cell and a second cell, and
Means for calculating a transmission power related parameter used for determining an uplink transmission power for the first cell based on the relational parameter.

The third aspect may be modified as follows:

The relationship may be a relative position between the first cell and the second cell.

The relational parameter may be an estimated pathloss between the first cell and the second cell.

The apparatus may comprise means for calculating the transmission power related parameter based on the following formula:

P_{o-LeNB}=min{P_{o MAX}, Aₐ+Bₐ*PL_{LeNB-eNB}}
wherein P_{o-LeNB} is the transmission power related parameter, P_{o MAX} is a maximum value of the transmission power related parameter, PL_{LeNB-eNB} is the estimated pathloss between the first cell and the second cell, and Aₐ and Bₐ are predefined parameters.

The relational parameter may be an estimated average level of interference perceived at the position of the apparatus.

The apparatus may comprise means for calculating the transmission power related parameter based on the following formula:

P_{o-LeNB}=Min{P_{o MAX}A_{b}+B_{b}*I_{LeNB}}
wherein P_{o-LeNB} is the transmission power related parameter, P_{o-MAX} is a maximum value of the transmission power related parameter, I_{LeNB} is the estimated average level of interference perceived at the position of the apparatus, and A_{b} and B_{b} are predefined parameters.

The apparatus may be a first network control apparatus (e.g., a LeNB or a HeNB) serving the first cell, and the second cell is served by a network control apparatus (e.g., an eNB or a WAeNB) being nearest to the first network control apparatus.

The apparatus may further comprise means for sending the transmission power related parameter and/or the relational parameter to a network configuration apparatus.

The apparatus may comprise means for receiving a power command parameter for setting a transmission power from the network configuration apparatus, and may further comprise means for setting the transmission power based on the power command parameter.

The apparatus may comprise means for receiving measurements with respect to the relational parameter from a user equipment or may comprise means for performing measurements with respect to the relational parameter.

The apparatus may comprise means for setting the uplink transmission power by taking into account correction values, and for restrict the correction values.

The apparatus may comprise means for restricting the correction values by blocking a possibility of accumulating user correction values or correction values of the apparatus, and/or by restricting the amount of correction values to be used for setting the uplink transmission power.

According to a fourth aspect of several embodiments of the present invention, an apparatus is provided which comprises:
means for receiving a transmission power related parameter from a first network control apparatus controlling a first cell, wherein the transmission power related parameter depends on a relational parameter indicating a relationship between the first cell and a second cell,
means for determining a power command parameter for the first network control apparatus based on the transmission power related parameter.

The fourth aspect may be modified as follows:

The apparatus may comprise means for determining the power command parameter based on at least one of the following:
the relational parameter, and/or
settings of a power control algorithm of a second network control apparatus serving the second cell, and/or
level of uplink interference perceived by the second network control apparatus.

The relational parameter may be an estimated pathloss between the first cell and the second cell, and/or the relational parameter may be an estimated expected interference between the first cell and the second cell.

The apparatus may comprise means for using an interference indicator and/or an overload indicator for modifying the power command parameter.

The apparatus may comprise means for restricting correction values to be used for setting a transmission power of a user equipment by blocking a possibility of accumulating user correction values or correction values, and/or by restricting the amount of correction values to be used for setting the uplink transmission power.

According to a fifth aspect of several embodiments of the present invention, a method is provided which comprises:
obtaining a relational parameter indicating a relationship between a first cell and a second cell, and
calculating a transmission power related parameter used for determining an uplink transmission power for the first cell based on the relational parameter.

The fifth aspect may be modified as follows:

The relationship may be a relative position between the first cell and the second cell.

The relational parameter may be an estimated pathloss between the first cell and the second cell.

The transmission power related parameter may be calculated based on the following formula:

P_{o-LeNB}=min{P_{o MAX}, Aₐ+Bₐ*PL_{LeNB-eNB}}
wherein P_{o-LeNB} is the transmission power related parameter, P_{o MAX} is a maximum value of the transmission power related parameter, PL_{LeNB-eNB} is the estimated pathloss between the first cell and the second cell, and Aₐ and Bₐ are predefined parameters.

The relational parameter may be an estimated average level of interference perceived at the position of the apparatus.

The transmission power related parameter may be calculated based on the following formula:

P_{o-LeNB}=Min{P_{o MAX}, A_{b}+B_{b}*I_{LeNB}}
wherein P_{o-LeNB} is the transmission power related parameter, P_{o MAX} is a maximum value of the transmission power related parameter, I_{LeNB} is the estimated average level of interference perceived at the position of the apparatus, and A_{b} and B_{b} are predefined parameters.

The first cell may be served by a first network control apparatus, and the second cell may be served by a network control apparatus being nearest to the first network control apparatus.

The method may further comprise sending the transmission power related parameter and/or the relational parameter to a network configuration apparatus.

The method may further comprise
receiving a power command parameter for setting a transmission power from the network configuration apparatus, and
setting the transmission power based on the power command parameter.

The obtaining comprises receiving measurements with respect to the relational parameter from a user equipment, or using a user equipment receiver configured to perform measurements with respect to the relational parameter.

The method may further comprise setting the uplink transmission power by taking into account correction values, and restricting the correction values.

The correction values may be restricted by blocking a possibility of accumulating user correction values or correction values of the apparatus, and/or by restricting the amount of correction values to be used for setting the uplink transmission power.

According to a sixth aspect of several embodiments of the present invention, a method is provided which comprises:
receiving a transmission power related parameter from a first network control apparatus controlling a first cell, wherein the transmission power related parameter depends on a relational parameter indicating a relationship between the first cell and a second cell,
determining a power command parameter for the first network control apparatus based on the transmission power related parameter.

The sixth aspect may be modified as follows:

The method may further comprise
determining the power command parameter based on at least one of the following:
the relational parameter, and/or
settings of a power control algorithm of a second network control apparatus serving the second cell, and/or
level of uplink interference perceived by the second network control apparatus.

The relational parameter may be an estimated pathloss between the first cell and the second cell, and/or the relational parameter is an estimated expected interference between the first cell and the second cell.

The method may further comprise modifying the power command parameter by using an interference indicator and/or an overload indicator.

The method may further comprise restricting correction values to be used for setting a transmission power of a user equipment by blocking a possibility of accumulating user correction values or correction values, and/or by restricting the amount of correction values to be used for setting the uplink transmission power.

According to a seventh aspect of several embodiments of the present invention, a computer program product is provided which comprises code means for performing a method according to any one of the fifth and sixth aspects and their modifications when run on a computer.

The computer program product may be embodied on a computer-readable medium, and/or the computer program product may be directly loadable into an internal memory of the computer.

According to an eight aspect of several embodiments of the present invention, a computer program product embodied on a computer-readable medium is provided which comprises code means for performing, when run on a computer:
obtaining a relational parameter indicating a relationship between a first cell and a second cell, and
calculating a transmission power related parameter used for determining an uplink transmission power for the first cell based on the relational parameter.

According to an ninth aspect of several embodiments of the present invention, a computer program product embodied on a computer-readable medium is provided which comprises code means for performing, when run on a computer:
receiving a transmission power related parameter from a first network control apparatus controlling a first cell, wherein the transmission power related parameter depends on a relational parameter indicating a relationship between the first cell and a second cell,
determining a power command parameter for the first network control apparatus based on the transmission power related parameter.

In all of the above aspects, the second cell (e.g., a wide area cell) may be larger than the first cell (e.g., a small cell served by a LeNB or a HeNB).

It is to be understood that any of the above modifications can be applied singly or in combination to the respective aspects and/or embodiments to which they refer, unless they are explicitly stated as excluding alternatives.

For the purpose of the present invention as described herein above, it should be noted that
method steps likely to be implemented as software code portions and being run using a processor at a network element or terminal (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above, UE, eNode-B etc. as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined apparatuses, or any one of their respective means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

It is noted that the embodiments and examples described above are provided for illustrative purposes only and are in no way intended that the present invention is restricted thereto. Rather, it is the intention that all variations and modifications be included which fall within the spirit and scope of the appended claims.

1.-12. (canceled)

13. An apparatus comprising
a receiver configured to receive a transmission power related parameter from a first network control apparatus controlling a first cell, wherein the transmission power related parameter depends on a relational parameter indicating a relationship between the first cell and a second cell,
a processor configured to determine a power command parameter for the first network control apparatus based on the transmission power related parameter.

14. The apparatus according to claim 13, wherein the processor is configured to determine the power command parameter based on at least one of the following:
the relational parameter, and/or
settings of a power control algorithm of a second network control apparatus serving the second cell, and/or
level of uplink interference perceived by the second network control apparatus.

15. The apparatus according to claim 13, wherein the relational parameter is an estimated pathloss between the first cell and the second cell, and/or the relational parameter is an estimated expected interference between the first cell and the second cell.

16. The apparatus according to claim 13, wherein the processor is configured to use an interference indicator and/or an overload indicator for modifying the power command parameter.

17. The apparatus according to claim 13, wherein the processor is configured to restrict correction values to be used for setting a transmission power of a user equipment by blocking a possibility of accumulating user correction values or correction values, and/or by restricting the amount of correction values to be used for setting the uplink transmission power.

18. The apparatus according to claim 13, wherein the second cell is larger than the first cell.

19. A method, comprising
obtaining a relational parameter indicating a relationship between a first cell and a second cell, and
calculating a transmission power related parameter used for determining an uplink transmission power for the first cell based on the relational parameter.

20. The method according to claim 19, wherein the relationship is a relative position between the first cell and the second cell.

21. The method according to claim 19, wherein the relational parameter is an estimated pathloss between the first cell and the second cell.

22. The method according to claim 21, wherein the transmission power related parameter is calculated based on the following formula:
P_{o-LeNB}=min{P_{o MAX}, Aₐ+Bₐ*PL_{LeNB-eNB}}
wherein P_{o-LeNB} is the transmission power related parameter, P_{o MAX} is a maximum value of the transmission power related parameter, PL_{LeNB-eNB} is the estimated pathloss between the first cell and the second cell, and Aₐ and Bₐ are predefined parameters.

23. The method according to claim 19, wherein the relational parameter is an estimated average level of interference perceived at the position of the apparatus.

24. The method according to claim 23, wherein the transmission power related parameter is calculated based on the following formula:
P_{o-LeNB}=min{P_{o MAX}, A_{b}+B_{b}*I_{LeNB}}
wherein P_{o-LeNB} is the transmission power related parameter, P_{o MAX} is a maximum value of the transmission power related parameter, I_{LeNB} is the estimated average level of interference perceived at the position of the apparatus, and A_{b} and B_{b} are predefined parameters.

25. The method according to claim 19, wherein the first cell is served by a first network control apparatus, and the second cell is served by a network control apparatus being nearest to the first network control apparatus.

26. The method according to claim 19, further comprising
sending the transmission power related parameter and/or the relational parameter to a network configuration apparatus.

27. The method according to claim 26, further comprising
receiving a power command parameter for setting a transmission power from the network configuration apparatus, and
setting the transmission power based on the power command parameter.

28. The method according to claim 19, wherein the obtaining comprises receiving measurements with respect to the relational parameter from a user equipment, or using a user equipment receiver configured to perform measurements with respect to the relational parameter.

29. The method according to claim 19, further comprising setting the uplink transmission power by taking into account correction values, and restricting the correction values.

30. The method according to claim 29, wherein the correction values are restricted by blocking a possibility of accumulating user correction values or correction values of the apparatus, and/or by restricting the amount of correction values to be used for setting the uplink transmission power.

31. A method, comprising
receiving a transmission power related parameter from a first network control apparatus controlling a first cell, wherein the transmission power related parameter depends on a relational parameter indicating a relationship between the first cell and a second cell,
determining a power command parameter for the first network control apparatus based on the transmission power related parameter.

32. The method according to claim 31, further comprising
determining the power command parameter based on at least one of the following:
the relational parameter, and/or
settings of a power control algorithm of a second network control apparatus serving the second cell, and/or
level of uplink interference perceived by the second network control apparatus.

33. The method according to claim 31, wherein the relational parameter is an estimated pathloss between the first cell and the second cell, and/or the relational parameter is an estimated expected interference between the first cell and the second cell.

34. The method according to claim 31, further comprising
modifying the power command parameter by using an interference indicator and/or an overload indicator.

35. The method according to claim 31, further comprising
restricting correction values to be used for setting a transmission power of a user equipment by blocking a possibility of accumulating user correction values or correction values, and/or by restricting the amount of correction values to be used for setting the uplink transmission power.

36. The method according to claim 19, wherein the second cell is larger than the first cell.

37. A computer program product comprising a computer-readable storage medium for performing a method according to claim 19 when run on a computer.

38. (canceled)
